(19) United States
(12) Patent Application Publication
(10) Pub. No.: US 2015/0304230 A1
(43) Pub. Date: Oct. 22, 2015

(54) DYNAMIC MANAGEMENT OF A CLOUD COMPUTING INFRASTRUCTURE

(71) Applicant: HEWLETT-PACKARD DEVELOPMENT COMPANY, L.P., Houston, TX (US)

(72) Inventor: Adarsh SUPARNA, Karnataka (IN)

(21) Appl. No.: 14/429,552

(22) PCT Filed: Nov. 23, 2012
(86) PCT No.: PCT/IB2012/003111

§ 371 Date: Mar. 19, 2015

(30) Foreign Application Priority Data
Sep. 27, 2012 (IN) 4026/CHE/2012

(51) Int. Cl. H04L 12/911; H04L 12/46; H04L 12/26

(52) U.S. Cl. CPC H04L 47/70; H04L 43/08; H04L 12/462

(57) ABSTRACT

Provided is a method of dynamically managing a cloud computing infrastructure. A cloud computing infrastructure is configured on a cloud service provider based on a parameter. The parameter is monitored for a variation. If the variation in the parameter is more than a predefined level associated with the parameter, an action is performed related to operation of the cloud computing infrastructure

### BACKGROUND

Cloud computing has evolved as an alternate model to regular computing operations of an enterprise. Generally speaking, cloud computing involves delivery of computing as a service rather than a product, whereby shared resources (software, storage resources, etc.) are provided to computing devices as a service. The resources are shared over a network, which is typically the Internet. Cloud computing provides easy and scalable access to computing resources and information technology (IT) services.

### BRIEF DESCRIPTION OF THE DRAWINGS

For a better understanding of the solution, embodiments will now be described, purely by way of example, with reference to the accompanying drawings, in which:

FIG. 1 illustrates a computing infrastructure environment for facilitating dynamic management of a cloud computing infrastructure, according to an example.

FIG. 2 shows a block diagram of a bridge module hosted at a computer system, according to an example.

FIG. 3 illustrates a flow chart of a method of dynamically managing a cloud computing infrastructure, according to an embodiment.

### DETAILED DESCRIPTION OF THE INVENTION

Cloud computing service providers typically offer their services according to three formats: Infrastructure-as-a-Service (IaaS), Platform-as-a-Service (PaaS) and Software-as-a-Service (SaaS).

In Infrastructure-as-a-Service (IaaS) model, computing infrastructure is delivered as an outsourced service. An enterprise outsources the equipment used to support operations, including storage, hardware, servers and networking components to a cloud computing service provider, who in turn charges the user on the basis of “Pay as you go” model. Under IaaS model, therefore, the users pay for only what they use.

There are many cloud service providers who provide Infrastructure as a Service (IaaS). These cloud service providers may offer different cost structures and features at different times. Presently, if a user is availing IaaS from a cloud service provider and is not satisfied with the services being provided, there's no automatic way for the user to switch to another service provider. A cloud administrator cannot automatically port the cloud computing infrastructure from one service provider to another. If the user decides to switch to another service provider, the cloud administrator would be required to build the cloud computing infrastructure again. Needless to say, a lot of time may be required to create a similar infrastructure with a different service provider, since it would be a manual process and prone to error.

Proposed is solution for dynamically managing a cloud computing infrastructure. The proposed solution describes a bridge in an IaaS controller (IaaS), which is a generic layer used to create infrastructure on any service provider. The bridge would facilitate an automatic management of a cloud computing infrastructure on a cloud service provider. In an implementation, an automatic migration of a cloud computing infrastructure takes from an initial host cloud service provider to an alternative cloud service provider upon satisfaction of a predefined condition or parameter.

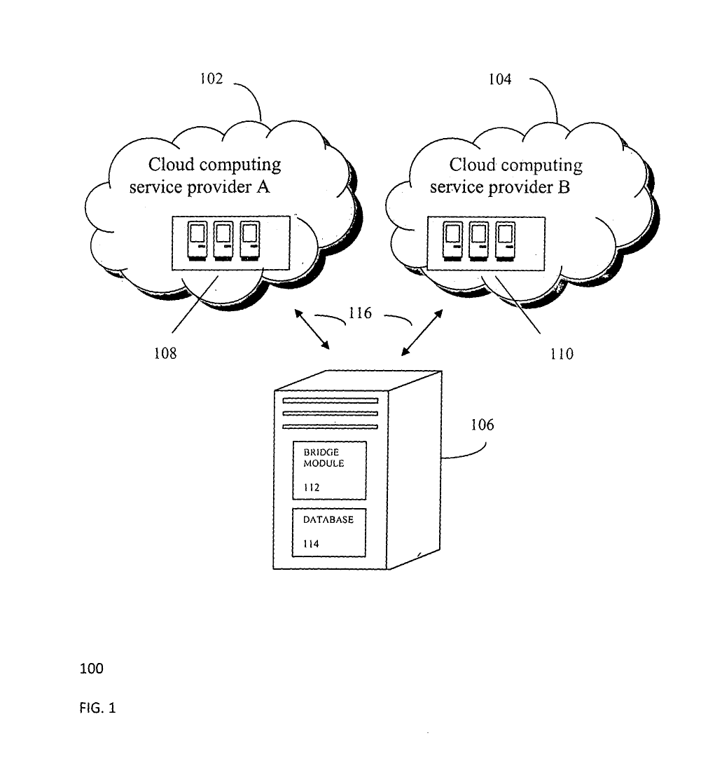

FIG. 1 illustrates a computing infrastructure environment for facilitating dynamic management of a cloud computing infrastructure, according to an example. As illustrated, computing infrastructure environment 100 includes cloud computing infrastructure 108 hosted by cloud computing service provider “A” 102, a cloud computing service provider “B” and user computer system 106.

Cloud computing service provider “A” 102 may include various types of computing resources. These computing resources may be hardware resources, software resources, or any combinations thereof. For example, hardware resources may include computer systems, computer servers, workstations, or any other computer devices. And, software resources may include operating system software (machine executable instructions), firmware, and/or application software. Computing resources may also include virtual machines, virtual servers, storage resources, load balancers, firewalls, etc. In an implementation, some or all of the computing resources provided by cloud computing service provider “A” 102 may be utilized by a user (customer) of cloud computing service provider “A” 102. Computing resources (of a cloud service provider) which are used (or hired) by a user constitutes the cloud computing infrastructure of the user on that service provider. In the present illustration, cloud computing infrastructure 108 on cloud computing service provider “A” 102 constitutes the cloud computing infrastructure of a user. Cloud computing infrastructure 108 may comprise any or all of the aforementioned hardware or software resources offered by cloud computing service provider “A” 102.

In an implementation, cloud computing infrastructure 108 may be managed through user computer system 106, which is communicatively coupled to cloud computing service provider “A” 102 through computer network 116. User computer system 106 may be, for example, a computer server, desktop computer, notebook computer, tablet computer, mobile phone, personal digital assistant (PDA), or the like. User computer system 106 may include a processor for executing machine readable instructions and a memory (storage medium) for storing machine readable instructions. In an implementation, user computer system is also communicatively coupled to another cloud computing service provider “B” 104 through computer network 116. In another implementation, user computer system may be communicatively coupled to cloud computing service provider “B” 104 through computer network. Computer network 116 may be a physical or wireless network.

In an implementation, user computer system 106 hosts a bridge module 112 and database 114.

Bridge module 112 facilitates migration of a cloud computing infrastructure from a cloud computing service provider to another cloud computing service provider without any manual intervention.

Database 114 maintains configuration parameters of a cloud computing infrastructure hosted with a cloud computing service provider. For instance, these may be configuration factors that are defined by a cloud administrator while setting-up a cloud computing infrastructure. Database 114 may also store rules (or conditions) for moving for moving a cloud computing infrastructure from one service provider to another service provider. These conditions may include, by way of example and not limitation, parameters like time, change in cost, change in performance, change in network parameters etc. of a cloud computing infrastructure.

In an operating environment, bridge module 112 monitors the state of a cloud computing infrastructure and identifies any changes made thereto. In case a change in a parameter is identified, bridge module 112 refers to database 114, for a comparison with original configuration parameters (of the cloud computing infrastructure) that are store therein. If upon comparison it is found that a change in parameter has occurred and the change is more than a pre-defined level configured for that parameter, an event may be generated which may result in bridge module 112 performing an action related to operation of the cloud computing infrastructure. In an implementation, changes may be made to configuration parameters like I/O access. Such type of information may obtained by bridge module 112 from Application Programming Interface (API) exposed by the cloud computing service provider. Bridge module 112 may collect this information periodically (configurable interval) thereby ensuring that it gets the latest and correct configuration. In another implementation, if bridge module 112 is unable to obtain the configuration parameters from a cloud computing service provider, it may use the information in database to rebuild the infrastructure.

In an implementation, an action related to operation of the cloud computing infrastructure includes migration of the cloud computing infrastructure from an original cloud service provider to an alternative cloud service provider. In such case, by using bridge module 112, a cloud administrator is not required to manual recreate the earlier cloud computing infrastructure in the new cloud computing service provider.

In an implementation, cloud computing infrastructure 108 is based on

Infrastructure as-a-Service (IaaS) model i.e. it is an IaaS cloud structure. Also, in an implementation, bridge module 112 may be part of an IaaS controller (IaasSC). IaaSC is a generic layer used to create infrastructure on any service provider. In another implementation, bridge module may be a distinct module.

It is noted that although relatively few cloud computing service providers are illustrated in FIG. 1 by way of example, other implementations may include additional cloud computing service providers.

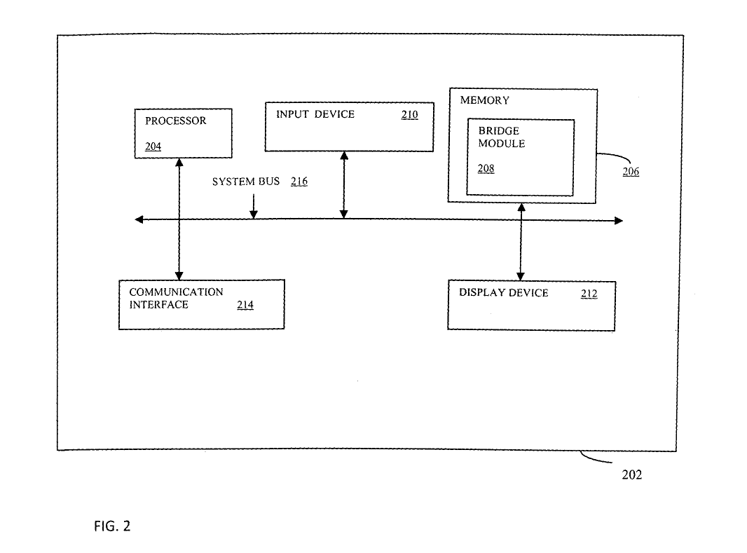

FIG. 2 shows a block diagram of a bridge module hosted at a computer system, according to an example.

Computer system 202 may be a computer server, desktop computer, notebook computer, tablet computer, mobile phone, personal digital assistant (PDA), or the like.

Computer system 202 may include processor 204, memory 206, bridge module 208, input device 210, display device 212, and a communication interface 214. The components of the computing system 202 may be coupled together through a system bus 216.

Processor 204 may include any type of processor, microprocessor, or processing logic that interprets and executes instructions.

Memory 206 may include a random access memory (RAM) or another type of dynamic storage device that may store information and instructions non-transitorily for execution by processor 204. For example, memory 206 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 206 may include instructions that when executed by processor 204, implement bridge module 208.

Bridge module 208, in an implementation, dynamically manages a cloud computing infrastructure, by configuring the cloud computing infrastructure on a cloud service provider based on a parameter; monitoring the parameter for a variation; and performing an action related to operation of the cloud computing infrastructure if the variation in the parameter is more than a predefined level associated with the parameter. In an implementation, the action may comprise migration of the cloud computing infrastructure to an alternative cloud service provider. In another implementation, the action may comprise increasing capacity for the cloud computing infrastructure on the cloud service provider.

Bridge module 208 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, bridge module 208 may be read into memory 206 from another computer-readable medium, such as data storage device, or from another device via communication interface 216.

Input device 210 may include a keyboard, a mouse, a touch-screen, or other input device. Display device 212 may include a liquid crystal display (LCD), a light-emitting diode (LED) display, a plasma display panel, a television, a computer monitor, and the like.

Communication interface 214 may include any transceiver-like mechanism that enables computing device 202 to communicate with other devices and/or systems via a communication link. Communication interface 214 may be a software program, a hard ware, a firmware, or any combination thereof. Communication interface 214 may provide communication through the use of either or both physical and wireless communication links. To provide a few non-limiting examples, communication interface 214 may be an Ethernet card, a modem, an integrated services digital network (“ISDN”) card, etc.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

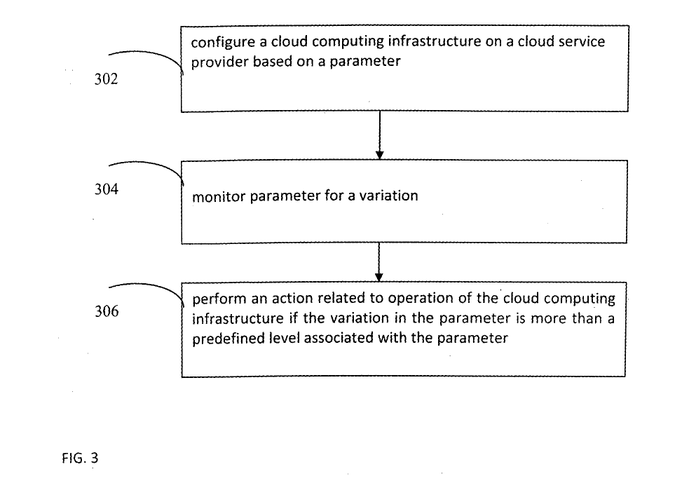

FIG. 3 illustrates a flow chart of a method of dynamically managing a cloud computing infrastructure, according to an embodiment. At block 302, a cloud computing infrastructure is created (or configured) on a cloud service provider based on a parameter or multiple parameters. The aforesaid cloud service provider may be termed initial host cloud service provider. In an implementation, the cloud computing infrastructure could be a configured by a cloud administrator through a user computer system which is communicatively coupled to the initial host cloud service provider through a computer network. To provide an illustration with reference to FIG. 1, a cloud computing infrastructure 108 is configured on cloud computing service provider “A” 102 with the help of user computer system 106. In an implementation, the configuration settings of cloud computing infrastructure and its parameter(s) may be stored in a database on user computer system 106. In other implementations, these settings may be stored in a component of the cloud computing infrastructure. Parameters define the rules (or conditions) for moving a cloud computing infrastructure from a host cloud computing service provider to another cloud computing service provider. These conditions may include, by way of example and not limitation, time, change in cost, change in performance, change in network conditions etc. of a cloud computing infrastructure. Each parameter defined for a cloud computing infrastructure is associated with its acceptance value (level) as well. The acceptance level of a parameter which may be pre-defined (by system or user) is a value beyond which an event or action may be triggered related to operation of the cloud computing infrastructure.

In an implementation, additional (or secondary) cloud computing service providers may also be configured. In another implementation, a cloud computing infrastructure is configured based on a combination of parameters.

At block 304, parameter(s) defined for the cloud computing infrastructure are monitored for a variation (or change). For example, if the parameter defined was time, cloud computing infrastructure is monitored based on this parameter. In another example, if the parameter was cost, then cost related to cloud computing infrastructure is monitored. In an implementation, if a cloud computing infrastructure is configured based on a combination of parameters, all those parameters are monitored for variation.

At block 306, an action related to operation of the cloud computing infrastructure is performed if the variation in the parameter is more than a predefined level associated with the parameter. As mentioned earlier, a parameter defined for a cloud computing infrastructure is tagged with an acceptance value (level). The acceptance level of a parameter which may be pre-defined (by system or user) is a value beyond which an action related to operation of the cloud computing infrastructure may be performed. For example, if the parameter defined for a cloud computing infrastructure on a cloud service provider is time and its associated value is 11:00 PM, an automatic action related to operation of the cloud computing infrastructure is performed at 11:00 PM. In another example, if the parameter defined for a cloud computing infrastructure is cost of the cloud computing service provider and its associated value is USD 5000, an automatic action related to operation of the cloud computing infrastructure is performed when cost of the cloud computing service provider exceeds USD 5000. In an implementation, if a cloud computing infrastructure is configured based on a combination of parameters, and all or any of those parameters (depending on how they are configured) are different from their pre-defined levels, action related to operation of the cloud computing infrastructure may be performed.

A number of actions related to operation of the cloud computing infrastructure are possible. Some non-limiting examples of these actions are described below. In an implementation, an action may include migration of the cloud computing infrastructure from its host cloud computing service provider to an alternative cloud computing service provider. To provide an illustration with reference to FIG. 1, cloud computing infrastructure 108 configured on cloud computing service provider “A” 102 may be migrated to cloud computing service provider “B” if the variation in the parameter is more than a predefined level associated with the parameter. In an implementation, the host cloud service provider is a private cloud and the alternative cloud service provider is a public cloud. In another implementation, the host cloud service provider is a public cloud and the alternative cloud service provider is a private cloud.

In another implementation, an action may include increasing the capacity for the cloud computing infrastructure on the cloud service provider. For example, if upon monitoring it is determined that the cloud computer infrastructure has reached its full capacity on its host cloud service provider, a request may be made to the cloud service provider for increasing the capacity of cloud computing infrastructure, for example by adding new virtual machine, storage resources etc. The expansion may be carried out on the same cloud service provider or on a different cloud service provider.

The proposed solution would avoid recreating infrastructure repeatedly. The same bridge can be used to create infrastructure for different business units across an organization. Also manual monitoring of cloud infrastructure is not needed since both activities (extension of infrastructure or movement to another service provider) are performed automatically.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

1. A method of dynamically managing a cloud computing infrastructure, comprising:
configuring the cloud computing infrastructure on a cloud service provider based on a parameter;
monitoring the parameter for a variation; and
performing an action related to operation of the cloud computing infrastructure if the variation in the parameter is more than a predefined level associated with the parameter.

2. The method of claim 1, wherein the action comprises migration of the cloud computing infrastructure to an alternative cloud service provider.

3. The method of claim 2, wherein the cloud service provider is a private cloud and the alternative cloud service provider is a public cloud.

4. The method of claim 2, wherein the cloud service provider is a public cloud and the alternative cloud service provider is a private cloud.

5. The method of claim 2, wherein configuration information of the cloud computing infrastructure is used for migration of the cloud computing infrastructure to an alternative cloud service provider.

6. The method of claim 1, wherein the action comprises increasing capacity for the cloud computing infrastructure on the cloud service provider.

7. The method of claim 1, wherein the parameter includes one of the following: time, cost, performance, or state of a network hosting the cloud computing infrastructure.

8. The method of claim 1, wherein the parameter and the predefined level associated with the parameter is stored in a database.

9. The method of claim 1, wherein the cloud computing infrastructure is based on an Infrastructure-as-a-Service (IaaS) model of cloud computing.

10. A system, comprising:
a bridge module, wherein the bridge module monitors a cloud computing infrastructure on a host cloud service provider for a change in a parameter; and
performs an action related to operation of the cloud computing infrastructure if the variation in the parameter is more than a predefined level associated with the parameter.

11. The system of claim 10, further comprising a database for storing the parameter and the predefined level associated with the parameter.

12. The system of claim 10, wherein the action includes recreating the cloud computing infrastructure on an alternate cloud service provider.

13. The system of claim 12, wherein the recreation comprises obtaining configuration information used for creating the cloud computing infrastructure on the host cloud service provider.

14. The system of claim 10, the parameter includes one of the following: time, cost, performance, or state of a network hosting the cloud computing infrastructure.

15. A non-transitory processor readable medium, the non-transitory processor readable medium comprising machine executable instructions, the machine executable instructions when executed by a processor causes the processor to:
to monitor a cloud computing infrastructure on a host cloud service provider for a change in a parameter; and
to perform an action related to operation of the cloud computing infrastructure if the variation in the parameter is more than a predefined level associated with the parameter, wherein the action comprises migration of the cloud computing infrastructure to an alternative cloud service provider
